(19) United States
(12) Patent Application Publication
(10) Pub. No.: US 2007/0176775 A1
(43) Pub. Date: Aug. 2, 2007

(54) Security door apparatus

(76) Inventor: David White, Seven Oaks (GB)

Correspondence Address: PATZIK, FRANK & SAMOTNY LTD., 150 SOUTH WACKER DRIVE, SUITE 1500, CHICAGO, IL, 60606, US

(21) Appl. No.: 11/359,309

(22) Filed: Feb. 17, 2006

(30) Foreign Application Priority Data
Jan. 30, 2006 (GB) 0601815.4

(51) Int. Cl. E05B 45/06; E05B 43/00; G05B 19/00

(52) U.S. Cl. 340/542; 340/5.64; 70/271

(57) ABSTRACT

A security door apparatus where electric and electronic parts thereof are powered an internal power supply and the door incorporates enhanced power saving features which may be implemented in simple cost effective fashion, as well as improved alarm and monitoring units for security purposes.

This application claims priority to GB Application No. 0601815.4, filed Jan. 30, 2006, the entirety of which is hereby incorporated by reference.

### FIELD OF THE INVENTION

The present invention relates to a security door apparatus typically used in vacant properties and similar situations where a property is left unattended for a substantial period of time.

### BACKGROUND OF THE INVENTION

If a building is left vacant for more than a short period of time (for example, to carry out renovation works), it becomes vulnerable to people breaking into the building for the purposes of theft, squatting or vandalism. The normal doors and windows of a building do not provide a high degree of security so it is known to cover the windows to make it more difficult to enter into the building.

A rudimentary way of covering an entranceway is to fasten a wooden board over the outside of the window or door, but this is relatively easy to remove by someone determined to enter the building.

It also is known to provide security door assemblies which offer a higher degree of security than the above-mentioned rudimentary approach. A security door assembly which is secured over an existing entranceway into a building is described in EP 0 141 623. The assembly comprises a door hingedly mounted in a frame with the assembly braced in the entranceway. The assembly is provided with locks which prevent the door from moving about its hinges from a position located in the doorframe. A particularly advanced security door apparatus is known from EP-A-0 728 887, though if all possible features of this door are incorporated in a production door, the door becomes expensive to manufacture.

The security door assemblies are normally temporarily installed on a building, as mentioned above, during renovation or building works. The known door assemblies incorporate mortise locks to secure the door in the door frame because mortise locks provide straightforward fitting and a reasonable degree of security.

Mortise locks do, however, have a number of disadvantages. Firstly, the keyhole allows for the possibility that the lock can be picked. In order to decrease the likelihood of this occurring, complex and expensive locking mechanisms are often used and some manufacturers only use their own locks on their doors. The use of such complex locks, in itself, can be disadvantageous because this requires the change of complete locking mechanisms when a door is moved from site to site.

A particular manufacturer/source is likely to have many thousands of doors in circulation at any time, with many thousands of people having keys to one or more of the doors. The above factors mean that there is a likelihood that some people may have the keys to a door which they are not authorized to enter. Commercially, this means that the issue and return of keys must be carefully monitored and also that installation teams from the manufacturer/source have to carry a key of every design manufactured, which is expensive and leads to the possibility of theft of a full set of keys.

Further, mortise locks are prone to vandals causing damage to the locks by inserting glue into the keyhole, or by trying to force the locks. It is known to put sliding covers in the keyhole to prevent such abuse, but this does not entirely overcome the problem.

Electronic locks are often used in security doors as electronic locks do not require several physical keys in existence for a particular door. However, temporary security doors do not normally have a permanent power supply and so the power supply has to be contained with the security door apparatus. Yet this can pose a problem as the security doors may remain in place for several months or even years and the power supply must not fail over this period.

The overall effectiveness of the locks against forced or otherwise unauthorized entry is clearly of primary importance with security door assemblies.

### SUMMARY OF THE INVENTION

The present invention seeks to provide a security door apparatus which is secure whilst being simple to manufacture and reliable in operation.

According to the present invention, there is provided a security door apparatus including an electronic lock powered by an internal power supply, the electronic lock having a keypad for input of a code for unlocking the electronic lock, wherein the electronic lock is only powered for a predetermined period after a switch is activated (e.g., by pressing a key). The intermittent powering of the electronic lock greatly increases the life of the internal power supply, yet may be implemented in a mechanically simple fashion and so does not greatly add to the cost or complexity of the door apparatus.

For example, the switch can be a key on the keypad or could be a separate button (for example, disguised as a screw fixing the keypad). In a preferred embodiment, the switch must be depressed to power the electronic lock and, in some cases, the electronic lock is only powered whilst the switch remains in the activated position to minimize the time the circuitry is powered.

In a preferred embodiment, the electronic lock prevents movement of a door opener to an open position when the electronic lock is in a locked position. Thus, the electronic lock is used to hold a mechanical door opener.

It is preferred that, in such cases, a further code must be entered into the keypad after the door opener is moved to the open position to disarm an alarm unit. The alarm unit will often be monitored and, if an unauthorized person attempts to enter the building, the alarm unit can make appropriate notifications even if the unauthorized person manages to physically open the security door apparatus.

It is known for a security door to have an alarm unit associated therewith. The alarm unit may be monitored by a remote monitoring station often by a telephone connection. It is preferred in the present invention for the alarm unit to be armed (i.e., set to monitoring status) by the action of a door opener (e.g., a handle) moving to the closed position. This can be either an automatic function of the door apparatus or may require the person exiting the door to positively move the opener to a closed position. This feature may be used in any door with an alarm unit associated therewith.

### BRIEF DESCRIPTION OF THE DRAWINGS

The present invention will now be described with reference to the accompanying drawings, in which:

FIG. 1 schematically illustrates a first embodiment of a monitoring station useful in the present invention;

FIG. 2 schematically illustrates a second embodiment of a monitoring station useful in the present invention;

FIG. 3 schematically illustrates a third embodiment of a monitoring station useful in the present invention;

FIG. 4 schematically illustrates a fourth embodiment of a monitoring station useful in the present invention;

FIG. 5 schematically illustrates a fifth embodiment of a monitoring station useful in the present invention;

FIG. 6 is a perspective view of an alarm unit according to an embodiment of the present invention;

FIG. 7 is a perspective view of one embodiment of a portable security door apparatus to which the alarm unit of FIG. 6 can be fitted;

FIG. 8 is a front elevated view of one embodiment of a security door apparatus according to an embodiment of the present invention; and

FIG. 9 is a front elevated view of a further embodiment of a security door apparatus.

### DETAILED DESCRIPTION OF THE INVENTION

While this invention is susceptible of embodiment in many different forms, there is shown in the drawings and will herein be described in detail several specific embodiments, with the understanding that the present disclosure is to be considered merely an exemplification of the principles of the invention and the application is limited only to the appended claims.

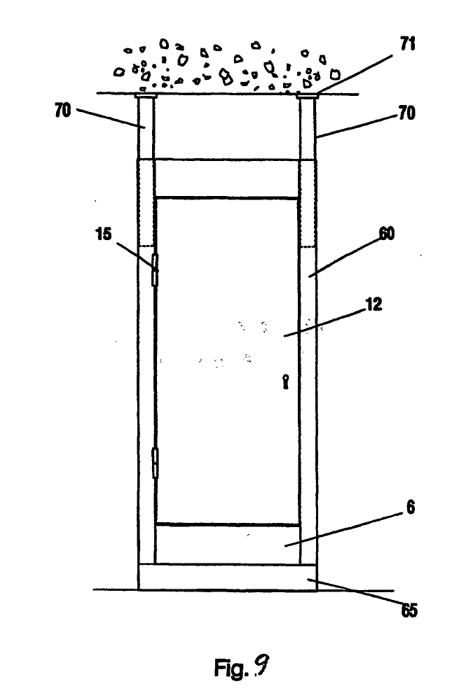

FIGS. 7, 8 and 9 show an embodiment of a security door apparatus 10 for mounting exteriorly to a dwelling or other building entrance. The door apparatus 10 comprises a door frame 60 on which is hingedly mounted a door 12. Normally, the door frame 60 will be mounted in an existing doorway of the dwelling braced between the door jamb, the threshold and the lintel of the entranceway, or affixed to the existing frame.

The door 12 is mounted to the door frame 60 on hinges 15 to move hingedly between an open position where the exterior surface of the door 12 is not aligned with the exterior surface of the frame 60 and a closed position where the exterior surface of the door 12 and the frame 60 are substantially coplanar. In the closed position, the door frame 60 prevents any substantial vertical, horizontal, or rotational movement of the door 12 in the door frame 60. The door apparatus 10 is kept vertically in place, by means of an expanding threshold 65 and telescopic legs 70 which may be as described in EP-A-0 728 887, the disclosure of which is hereby incorporated by reference.

In FIG. 8, the door frame 60 comprises an upright hinged side member 61 joined at the top to one end of a top frame member 62 which is joined at the other end to a lock side member 63. The two side members 61, 63 are joined at the base by bottom frame member 64 to define a door opening. A U-shaped member 16 is attached on the lock side of the main door panel 14 to enclose that side member 63 of the door frame. This is to protect the door assembly from forced entry by insertion of levers into the gap between the door frame 60 and the door 12.

The door 12 comprises a main door panel 14 with inwardly extending flanges. The door panel 14 is the same size as the opening in the door frame 60. The door is hinged on one side and has a door member 16 fixed on the other side of the door panel 14. The door member comprises a U-shaped section extending along the whole side of the door panel 14. One side of the U-shaped section is in face-to-face contact with the inwardly extending flange of the door panel 14. When the door is in the closed position, the door member 16 extends around the side member 63 of the door frame 60 with the rear frame panel.

In each of the illustrated embodiments, the hinges 15 are mounted with the pivot extending outwardly from the exterior surface of the door frame 60. If the hinges 15 are cut to separate the door 12 from the door frame 60, the door 12 cannot be removed from the door frame 60 because of members (not shown) extending from the inner flange of the door 12 into associated openings in the opposed surface of the door frame 60 and members (not shown) extending from the inner flange of the door frame 60 into associated openings in the opposed surface of the door frame inner flange. Alternative securing means could also be used.

The door apparatus 10 is fitted with security locks to prevent the door 12 moving from the closed position to the open position. The locks may take the form of normal mortise locks (as shown in FIG. 2) with or without disguised keyways or other similar anti-vandal devices. In the embodiment illustrated in FIG. 1, the door is fitted with the multiple lock security arrangement.

The door 12 has a handle 20 mounted on the exterior surface of the door 12. Handle 20 is used as the primary door opener and moves between an open position where the door 12 can swing on hinges 15 and a closed position where the door is retained in the door frame 60.

Opening 21 is a mortise lock key hole, but may in fact be a hole with no lock attached as this can act as a point that a vandal can attack without impinging on the function of the door apparatus.

A microswitch key pad (not shown) is mounted on the rear surface of the door panel 14. A metal plate is mounted on the exterior surface of the door panel 14. The metal plate has a finger pad 19 on the front surface thereof. The finger pad 19 may be disguised as a changeable street number of the door apparatus. The finger pad 19 comprises a plate with fingers 46 cut into the surface thereof. Depression of any finger 46 presses against an associated actuating member (not shown) which extends through the door panel 14. The microswitch key pad could, of course, be located on the exterior surface of the door in an armored case in a conventional manner. However, this is considered to be less secure than the illustrated embodiment because the microswitch keypad is more vulnerable to vandalism or other unauthorized tampering.

The microswitch key pad operates the electric lock (not shown) if the correct combination is input into the key pad 45 so that the electric lock moves between a locked and an unlocked position. In the locked position, the electric lock prevents door opener 20 from moving between the open and closed positions, whereas such movement is permitted when the electric lock is in the unlocked position.

The door apparatus also has an alarm unit 30 fitted to the interior thereof. The alarm unit 30 is used to detect unauthorized entry through the door 12, or attempted unauthorized entry. The electronic locks and alarm unit 30 are powered from an internal power source (not shown). Normally, the power supply is disconnected from the electronic lock and the alarm unit in order to preserve the operation time over which the internal power source will remain usable.

When a particular finger 46 is depressed, the power supply is connected to the electronic lock. If the correct unlock code is entered, the electronic lock releases handle 20 to be movable into its open position for a preset duration (e.g., 30 seconds). When the door 12 is opened, a further alarm code must be input through the finger pad 19 to disarm the alarm unit 30. If the alarm code is not appropriately entered, the alarm will sound as described in more detail below. If the alarm code is entered, an authorized entry can be made. After passing through the doorway, the door 14 is then moved back into line with the door frame 60 by the authorized person and held on a simple catch that is openable from the inside only so that a level of security remains for the door apparatus 10, even while authorized people are inside the dwelling or building. The catch is designed to prevent the handle 20 from moving back to its closed position whilst the catch is holding the door.

The alarm unit 30 is shown as a monitored alarm unit which is arranged so that the alarm unit 30 can contact a monitoring station by means of a telephone connection. In the illustrated embodiment, the alarm unit 30 has a built-in wireless connection (e.g., a GSM connection). The alarm unit 30 has a motion sensor in the form of an infrared sensor mounted thereon to detect movement whilst the alarm unit is powered.

Normally, the alarm unit 30 is not powered from the internal power supply in order to maximize the length of usable service of the power supply. When powered by someone depressing the appropriate finger pad 16 and when the correct unlock and alarm codes are input to unlock the electronic lock and disarm the alarm unit 30, the alarm unit 30 sends a call to say that a seemingly authorized entry has occurred. If powered, but the appropriate codes are not input, the alarm units send a call to say an unauthorized entry has been attempted. This may be set in such a way that the person trying to enter will be given a reasonable amount to enter the appropriate codes and/or be given a number of trials to input the appropriate codes before the unauthorized entry alarm call is made.

The internal power supply is then disconnected from the alarm unit 30 and the electronic lock. The power supply is re-connected when the person releases the simple catch to leave the property.

When the person leaves the property, the handle 20 is moved back to the closed position which automatically arms the alarm, and the alarm unit 30 contacts the monitoring station to say that the alarm unit 30 is again armed.

The alarm unit 30 and the electronic lock may be permanently powered, for instance in circumstances where the internal power supply can be routinely recharged due to the frequency of access to the property or where there is a permanent power supply available to effect permanent recharging.

In any case, the alarm unit 30 can be set to contact the monitoring station whenever the internal power supply is low or there is any interruption or unexpected event occurring with the power supply. The alarm unit 30 does not have to be used in connection with an electronic lock, but may be used with, among other things, a simple door apparatus with just a mortise lock as shown in FIG. 2. Unlocking the mortise lock then disarms the alarm unit 30, while locking it arms the alarm unit 30.

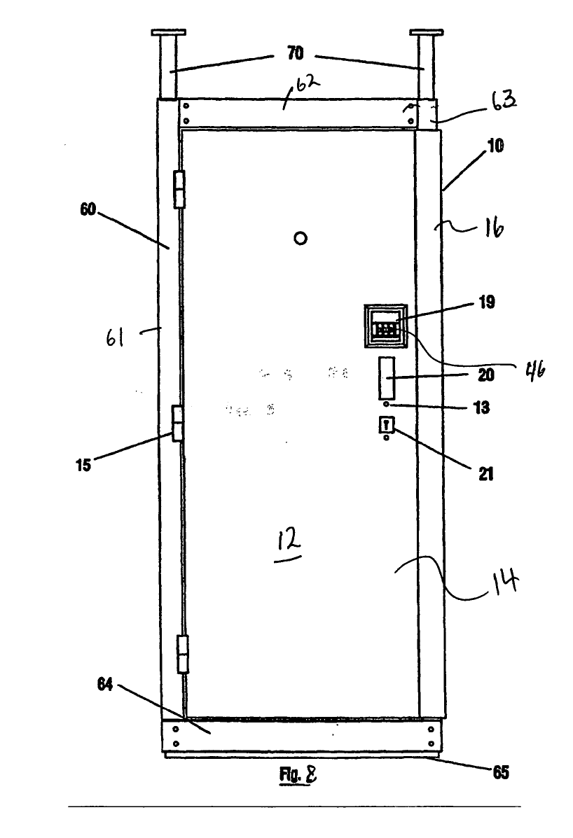

FIG. 6 shows a typical alarm unit 30, which can be fitted to a temporary or permanent structure such as a door 12 (shown in FIG. 8 or 9). The alarm unit 30 shown may have a strong plastic or metal case. If made from plastic, the unit may weigh about 1.5 kg and, when made from metal, the unit may weigh about 4.0 kg. Inside the case (not shown), the alarm circuitry and GSM transmitter will be located. In a preferred embodiment, the system is powered by a long duration Lithium cell which is designed to hold a charge for at least five years but can output the charge at relatively high levels. The alarm unit 30 will be programmed to contact the monitoring station 20 when unauthorized entry is attempted or affected on the door 12. The alarm unit 30 may also contact the monitoring station when the alarm is armed (i.e., door 12 closed and locked), disarmed (i.e., door 12 opened by authorized entry—e.g., with an appropriate code), and/or when the alarm unit 30 has a low battery and periodically (e.g., every 10 days) to show the monitoring unit that the particular alarm unit 10 is functioning.

The door 12 may be provided with electronic and/or key operated locks. The electronic locks will normally be operated through a keypad where the correct code needs to be entered to open the lock. However, the alarm unit 10 may also be programmed to operate an electronic lock on the door. In this way, where there are several doors in operation and, for example, several engineers or other outside contractors need access to various properties over time, there is a security risk in allowing all of these people to have door entry codes. The present invention can reduce the security risk by the contractors each being given an alarm contact code. The alarm code is input into the alarm unit via the normal door 12 keypad. The alarm unit 30 contacts the monitoring station 20, where details are kept of properties the contractors are permitted to access at any time. Often, the contractor will also have to contact the monitoring station separately by telephone to verify this information. If cleared, the alarm unit 30 can be used to unlock the door 12.

The alarm units 30 may be stand alone units or may be permanently mounted on a door 12 or other structure. The alarm units 30 may detect an alarm state by means of infrared sensors, incorrect codes being entered on an entry panel, breaking of an electrical or visual circuit or any other means as is common or known in the field of alarms. The size and appearance of the alarm unit 30 will vary depending upon what types of alarm states are being monitored.

FIGS. 1 to 5 show different embodiments of monitoring stations 20A to 20E which can be used in conjunction with alarm unit 30 in the present invention. The same numbers are used in the different figures to illustrate similar parts. All types of telephone networks now provide basic caller identification, such as a telephone number, when a call is directed to its recipient. This information is provided before the call is actually answered. Thus, for the basic operation of the invention, the alarm unit 30 (e.g., as shown in FIG. 6) can contact the monitoring station 20 via GSM modems, ISDN terminal adapters or modems on a PSTN telephone line. It is preferred to use a GSM or other mobile connection for a variety of reasons. Firstly, this allows the alarm unit 30 to be easily portable in temporary or non-fixed (e.g., vehicles, boats, statues) installations. Also, the basic SIM cards used in such mobile networks allow for a variety of numbers to be stored for dialing, and thereby facilitating implementation of the invention. It is also much more difficult to put an alarm out of communication with the monitoring station when there are no fixed phone lines.

FIG. 1 shows monitoring station 20A. This uses a personal computer 22. A call is received from the alarm unit, but this is not answered though the particular identification of the alarm unit that has called the monitoring station 20A is logged. The monitoring station records details of this call on the computer 22 such as time and alarm unit 30 identification. Depending upon the nature of the call, the monitoring station 20A will transmit information, if appropriate, via the GSM lines 24A, 24B. The first GSM line 24A transmits a voice message that a particular event has occurred at the relevant alarm unit 30. This transmission may be to a security company, the police or other designated recipient. Line 24B is used to transmit a Short Message Service (SMS) message to an intended recipient. The monitoring unit 20A is preferably a simple unit with only a single input line and so all calls from alarm units 30 will be alarm notifications.

Monitoring station 20B is a more complex unit, which has five input lines 26A-26E and three output lines 24A-24C. Line 26A receives the alarm signals. Line 26B receives calls that an alarm unit 30 is armed (i.e., set for surveillance) and line 26C receives calls on disarming of an alarm unit 30. Line 26D receives calls that each alarm unit 30 periodically is set to ensure that the alarm unit 30 is functioning correctly. Line 26E receives calls when an alarm unit 30 has a low battery or an interrupted power supply. The computer 22 will be set to log all of these calls, though of course none of the incoming calls will be answered. It will further be set to transmit information about the change in status of each alarm unit 30 that is being monitored via one or more of the three output lines 24A, 24B and 24C. Normally, all alarm notifications will be immediately further relayed as with monitoring station 20A. In monitoring station 22B, for example, the owners of the properties being monitored may wish to receive an SMS message each time a door is disarmed or when a low battery is detected. This monitoring unit is suitable for up to about 2500 alarm units 30, but further monitoring units 20B can be used if further alarm units 30 are to be monitored.

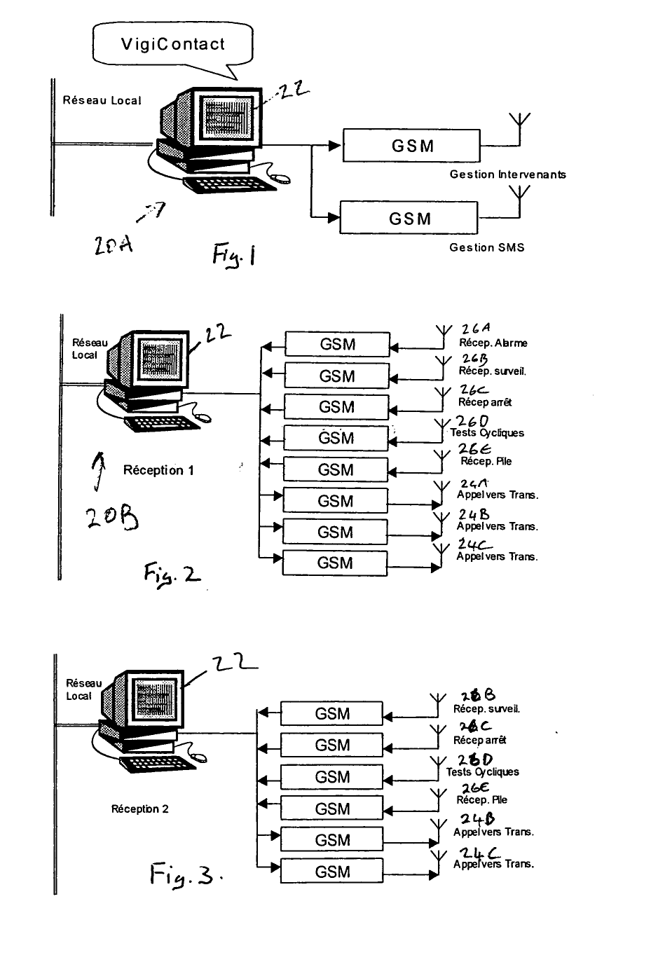

FIG. 3 shows a monitoring station 20C that is normally used in conjunction with a monitoring station 20A to provide the functionality of monitoring unit 20B. Units 20A, 20C do not have to be located physically together.

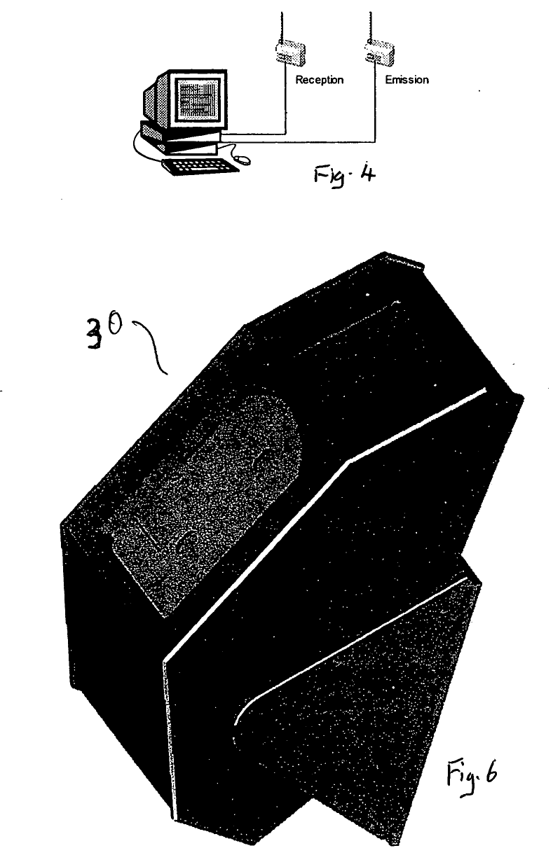

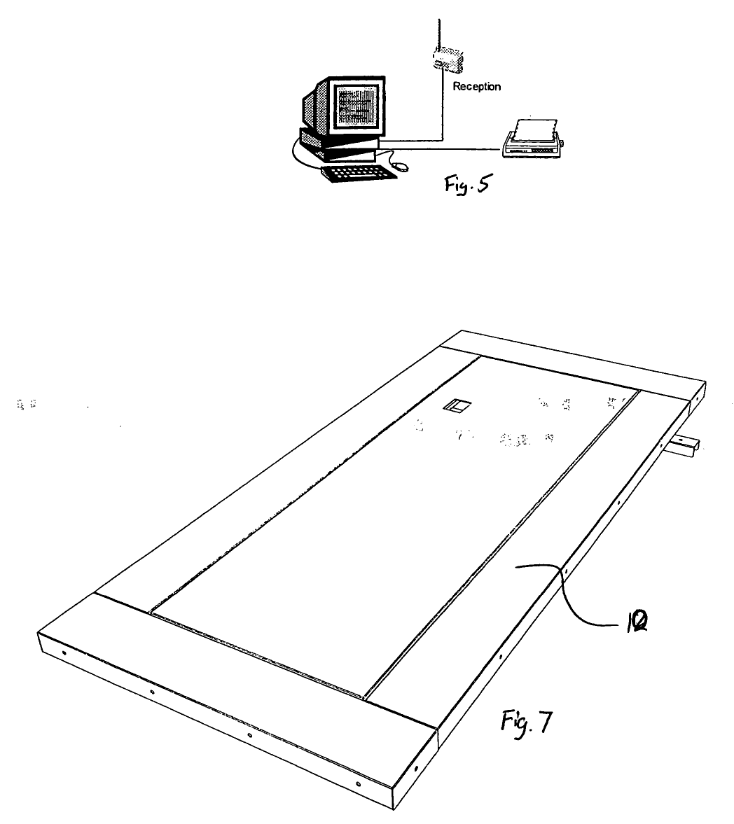

FIG. 4 shows a monitoring unit 20D that has a single GSM input line and a single GSM output line.

FIG. 5 shows a monitoring station 20E, which is, for example, used to receive calls from monitoring unit 20A via line 24A. It is appreciated that data may be further recorded at the monitoring unit 20A and/or 20E as soon as an alarm occurs.

Although the alarm unit 30 is particularly suited for installation on temporary security doors, it can also be used in a wide range of other places. It could be fitted to boats, cars or other vehicles. It could be included as part of a permanent building alarm or even as part of an item such as a statue.

Thus, the present invention relates to a security door apparatus where electric and electronic parts thereof are powered by an internal power supply and the door incorporates enhanced power saving features which may be implemented in simple cost effective fashion. The invention may also relate to the alarm units and monitoring stations for security purposes.

It will be understood that modifications and variations may be effected without departing from the scope of the novel concepts of the present invention, but it is understood that this application is limited only by the scope of the appended claims.

1. A security door apparatus comprising: an electronic lock powered by an internal power supply, the electronic lock having a keypad for input of a code for unlocking the electronic lock, and wherein the electronic lock is only powered for a predetermined period after a switch is activated.

2. The security door apparatus according to claim 1, wherein the switch is a key on the keypad.

3. The security door apparatus according to claim 1, wherein the switch must be depressed to power the electronic lock.

4. The security door apparatus according to claim 1, wherein the electronic lock is only powered whilst the switch remains in an activated position.

5. The security door apparatus according to claim 1, which further comprises an alarm unit.

6. The security door apparatus according to claim 5, wherein movement of a door opener to a closed position arms the alarm unit.

7. The security door apparatus according to claim 1, wherein the electronic lock prevents movement of a door opener to an open position when the electronic lock is in a locked position.

8. The security door apparatus according to claim 7, wherein a further code must be entered into the keypad after the door opener is moved to said open position to disarm an alarm unit.

9. A security door apparatus for a door comprising:
a power source;
an electronic lock operatively attached to the power source, wherein the electronic lock is normally not powered by the power source;
a door opener movable between a first or closed position and a second or opened position to selectively open the door;
means to provide power to the electronic lock from the power source for a predetermined amount of time; and
means to unlock the electronic lock to permit movement of the door opener to the opened position.

10. The security door apparatus of claim 9 wherein the means to unlock the electronic lock comprises a keypad for inputting a code.

11. The security door apparatus of claim 9 which further comprises an alarm unit.

12. The security door apparatus of claim 11 wherein the means to unlock the door comprises a keypad operatively connected to the electronic lock and the alarm unit, wherein a first code is input using the keypad to unlock the electronic lock, and wherein a second code is input using the keypad to prevent activation of an alarm from the alarm unit.

13. The security door apparatus of claim 12 which further comprises means to provide notification of an unauthorized entry.

14. A security door apparatus for a door comprising: a power source;
an electronic lock operatively attached to the power source;
a door opener movable between a first or closed position and a second or opened position to selectively open the door;
an alarm unit; and
a keypad operatively connected to the electronic lock and the alarm unit, wherein a first code is input using the keypad to unlock the electronic lock, and wherein a second code is input using the keypad to prevent activation of an alarm from the alarm unit.

15. The security door apparatus of claim 14 which further comprises means to power the electronic lock for a predetermined period of time.

16. The security door apparatus of claim 15 wherein the means to power the electronic lock for a predetermined period of time comprises a switch operatively attached to the electronic lock or power source.

17. The security door apparatus of claim 14 which further comprises means to provide notification of an unauthorized entry.
